(19) United States
(12) Patent Application Publication
(10) Pub. No.: US 2007/0215490 A1
(43) Pub. Date: Sep. 20, 2007

(54) METHOD OF ANALYZING ACCELERATOR FOR COPPER ELECTROPLATING

(75) Inventors: Wei-Ping Dow, Douliou (TW); Ming-Yao Yen, Douliou (TW); Hsiao-Chun Huang, Douliou (TW)

Correspondence Address: PAI PATENT & TRADEMARK LAW FIRM, 1001 FOURTH AVENUE, SUITE 3200, SEATTLE, WA, 98154, US

(73) Assignee: ROCKWOOD ELECTROCHEMICALS ASIA LTD., Chung Li City, Taoyuan Hsien (TW)

(21) Appl. No.: 11/308,356

(22) Filed: Mar. 18, 2006

(51) Int. Cl. G01N 27/26

(52) U.S. Cl. 205/775

(57) ABSTRACT

A method of analyzing accelerator of copper electroplating includes a selective adsorption step and an electrochemical deposition step. First, a gold electrode is placed into a plating solution, which contains organic additives. Then, the gold electrode is dipped in the plating solution for a while to adsorb the sulfur-containing accelerators. After the sulfur-containing accelerators are adsorbed on the gold electrode, the gold electrode is rinsed with Milli-Q ultra pure water. Then, the gold electrode is put into an electrolyte, which contains PEG and chloride ions to carry out a cathodic cyclic voltammetry (CCV) for copper deposition on the gold electrode. A calibration curve for the accelerator analysis can be obtained by integrating the polarization curve measured from the CCV.

### BACKGROUND

1. Field of Invention

The present invention relates to a method of analyzing accelerator concentration for copper electroplating. More particularly, the present invention relates to a method of analyzing accelerator concentration over a selective adsorption of sulfur-containing accelerators on a gold electrode and over an electrochemical copper deposition on the gold electrode.

2. Description of Related Art

Copper, due to its high conductivity and low resistance, is used in manufacturing conductive wire in semiconductor industry. Since electronic devices are always being made tinier and more complex, more and more problems are arising due to increasing wiring density and shortened distance between contacts. Therefore, the use of multi-layer circuit boards has become more common recently, which has caused metallization processes using electroplating to become significantly more complex.

Copper electroplating is more effective in manufacturing the metal wires and filling the microvias of a circuit board. Copper electroplating also has many advantages such as low required temperature, low cost, high deposition rate and easy processing. During the copper electroplating process, several additives must be added to the copper plating solution to produce fine filling performance. However, over a long period, the concentration and nature of the additives in the plating solution change substantially and may cause the plating solution to lose its filling ability. To improve electroplating quality, methods of analyzing the additive concentrations in the copper plating solution are therefore becoming crucial topics in this skill.

Generally, methods of determining accelerator concentration in the copper plating solution are based on selective adsorption of thiol molecules on metallic substrates such as Cu, Ag, and Au to form self-assembly monolayers (SAMs). For example, sulfur-containing accelerators form a sulfur-gold bonding to perform the selective adsorption, and the adsorbed sulfur-containing accelerators are stripped off from the gold electrode in an alkaline electrolyte by accepting electrons. Then, a stripping peak of reductive electrodesorption is produced and one can integrate the area of the stripping peak to obtain an amount of coulombic charge. The amount of charge is used to determine the content of sulfur-containing accelerators and analyze the concentration of accelerator in a plating bath. The foregoing method produces a weak electrochemical signal because only a monolayer of sulfur-containing molecule is adsorbed on the gold electrode surface. The electrochemical signal measured of the conventional method is in the μA/cm² range, imparting frequent errors. In addition, other additives in the plating solution affect the electrochemical activity of the accelerator, so the conventional method also cannot offer precise analysis of the accelerator content in a plating solution.

To reach the objective of monitoring the accelerator content of a plating solution, there is a need for an analytical method having high sensitivity and convenience for accelerator content determination of a plating solution.

### SUMMARY

The present invention is directed to a method of analyzing accelerator in copper electroplating that satisfies the need for precisely determining the accelerator content in a plating solution. The method is based on selective adsorption of thiol molecules on metallic substrates and electrochemical deposition of metallic copper particles in a deposition electrolyte. Using the method of the present invention the measured electrochemical signal can be amplified so as to substantially reduce the errors occurring in the conventional method.

It is therefore an objective of the present invention to provide a deposition electrolyte for depositing metallic copper particles on a gold electrode to amplify the measured electrochemical signal and solve the problem of the conventional method of low sensitivity.

In accordance with the foregoing and other objectives, a method of analyzing accelerator of copper electroplating is provided. The present invention is carried out by a selective adsorption step, and a cathodic cyclic voltammetry (CCV) for copper deposition. In addition, a deposition electrolyte for depositing metallic copper particles is provided.

First, a gold electrode is placed into a plating solution, which contains certain organic additives. The plating solution comprises a copper ion, an acid, a leveler, a polyethylene compound, a halogen, and an accelerator. The temperature of the plating solution is kept at 20˜30° C. during the analysis. The rotation speed of the gold electrode is adjusted to 3000 rpm (revolutions per minute) to remove the bubbles that attach to the gold electrode and then the rotation speed is zeroed. Next, the gold electrode is dipped into the plating solution for 15 to 45 minutes to pre-adsorb the sulfur-containing accelerators in the plating solution.

After the sulfur-containing accelerators are adsorbed on the gold electrode, the gold electrode is then rinsed with Milli-Q ultra pure water. Then, the gold electrode is put into a deposition electrolyte for copper electrodeposition by means of the cathodic cyclic voltammetry. A current peak in the cathodic cyclic voltammetry is obtained due to the copper deposition onto the gold surface, and the signal intensity of current density reaches the mA/cm² scale. Finally, the current peaks are integrated to obtain an amount of coulombic charge and plot a calibration curve. The calibration curve is used to determine the concentration of the accelerator in the plating bath.

In conclusion, the invention is based on existing analytical techniques, and combines a selective adsorption step and an electrochemical deposition step to amplify the measured electrochemical signal, so that a more accurate calibration curve can be obtained. It also allows accurate analysis of accelerator concentration and still relates to the existing analytical techniques to reach the objective of being more convenient and accurate.

The invention provides a deposition electrolyte for copper electrodeposition on the gold electrode by means of the cathodic cyclic voltammetry. A current peak in the cathodic cyclic voltammetry is obtained due to the copper deposition onto the gold surface, wherein the signal intensity of current density reaches the mA/cm² scale. Therefore, the relative error of measured sulfur-containing accelerators is reduced.

These and other features, aspects, and advantages of the present invention will become better understood with reference to the following description and appended claims.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 is a flowchart of steps of the method of analyzing accelerator according to the preferred embodiment of this invention.

FIG. 2 is the measurements of cyclic voltammetry.

FIG. 3 is a diagram of integrated results shown in FIG. 2 from the plating solution with various SPS concentrations.

FIG. 4 is a diagram of calibrated results of a plating solution that contained sulfuric acid, cupric sulfate and various SPS concentrations.

FIG. 5 is another diagram of calibrated results from an electrolyte that contained sulfuric acid, cupric sulfate, chloride ion and various SPS concentrations.

FIG. 6 is still another diagram of calibrated results from an electrolyte that contained sulfuric acid, cupric sulfate, PEG and various SPS concentrations.

FIG. 7 is another diagram of calibrated results comparing four electrolytes at various SPS concentrations.

FIG. 8 is the cyclic voltammetry within cathodic range from an electrolyte that contained sulfuric acid, cupric sulfate, PEG, chloride ion and various SPS concentrations.

FIG. 9 is the calibration curve obtained from the integrations of polarization curves shown in FIG. 8.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

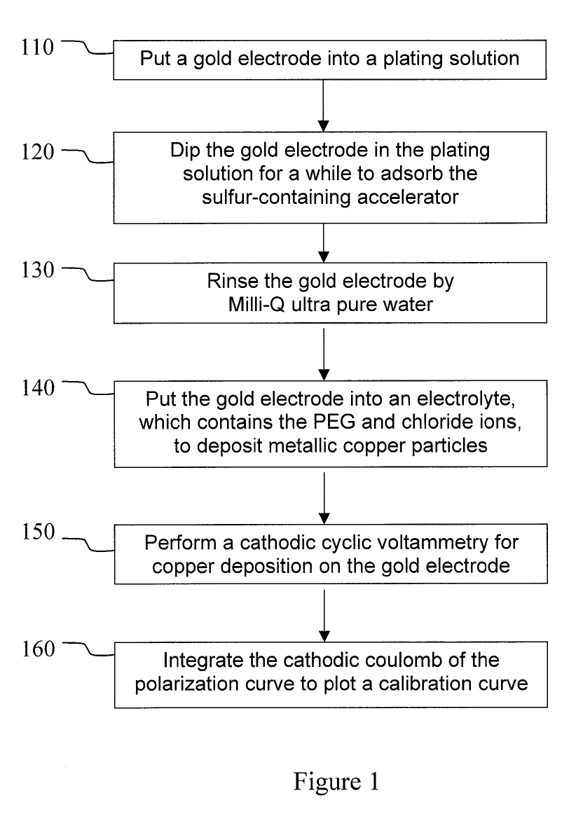

Reference is made to FIG. 1, which shows a flowchart of accelerator analysis according to the preferred embodiment of this invention. First, as shown in step 110, at the beginning of the analysis, a gold electrode is put into a plating solution, which contains organic additives. The rotation speed of the gold electrode is adjusted first to 3000 rpm to remove bubbles attached to the gold electrode and then to zero rpm. Next, the gold electrode is dipped in the plating solution for 15 to 45 minute to pre-adsorb sulfur-containing accelerators, wherein the temperature of the plating solution is kept at 20˜30° C. during the analysis.

According to the preferred embodiment of this invention, the plating solution comprises copper ions, an acid, a leveler, a polyethylene compound, a halogen, and an accelerator. The concentration of copper ions in the plating solution is about 150˜250 g/L. Copper ions are selected from the group consisting of cupric sulfate anhydrous, cupric sulfate (CuSO₄), cupric carbonate (CuCO₃), cupric nitrate (Cu(NO₃)₂), cupric oxide (CuO), and a mixture thereof. Preferably, the cupric sulfate (CuSO₄) is in the form of copper sulfate pentahydrate (CuSO₄.5H₂O). The acid is sulfuric acid (H₂SO₄), and the concentration of the sulfuric acid is about 30˜100 g/L. The concentration of the leveler is about 0.5˜5 ppm. The polyethylene compound is selected from the group consisting of polyethylene glycol (PEG), polypropylene glycol (PPG), polyethylene oxide (PEO), and polyethylene glycol tert-octylpheny ether (Triton X-405), and the concentration of the polyethylene compound is about 50˜400 ppm. The halogen is selected from the group consisting of chloride ion and bromide ion, and the concentration of the halogen is about 20˜100 ppm. The accelerator is selected from the group consisting of Bis-(3-Sulfopropyl) Disulfide (SPS), 3-Mercapto-1-Propane Sulfonate (MPS), N,N-dimethyl-dithiocarbamyl propyl sulfonic acid (DPS), 3-S-Isothiuronium propyl Sulfonate (UPS), and 3-(Benzothiazolyl-2-mercapto)-propyl-sulfonic acid (ZPS) and its concentration is adjusted to a proper concentration according to various requirements. Then, as shown in step 120, the sulfur-containing accelerators are selectively adsorbed as self-assembled monolayers onto the gold electrode. The amount of adsorbed sulfur-containing accelerators over the surface of the gold electrode is proportional to the dipping duration and the concentration of sulfur-containing accelerators in the plating solution.

Next, as shown in step 130, the gold electrode is rinsed with Milli-Q ultra pure water. Then, as shown in step 140, the gold electrode is put into the deposition electrolyte to do the cathodic cyclic voltammetry for copper deposition. The deposition electrolyte comprises copper ions, an acid, a polyethylene compound, and a halogen. The copper ion is selected from the group consisting of cupric sulfate, cupric sulfate (CuSO₄), cupric carbonate (CuCO₃), cupric nitrate (Cu(NO₃)₂), cupric oxide (CuO), and a mixture thereof. The acid is sulfuric acid (H₂SO₄), and the concentration of sulfuric acid is about 30˜100 g/L. The polyethylene compound is selected from the group consisting of polyethylene glycol (PEG), polypropylene glycol (PPG), polyethylene oxide (PEO), polyethylene glycol tertoctylphenyl ether (Triton X-405), and a mixture thereof. The molecular weight of the polyethylene compound is about 1000 to 20000 and the concentration is about 50˜400 ppm. The halogen is selected from the group consisting of chloride ion and bromide ion, and the concentration of the halogen is about 30˜100 ppm.

Next, as shown in step 150, the copper deposition is carried out using cathodic cyclic voltammetry at a scan rate of 1˜20 mV/sec. A current peak is obtained due to the copper deposition onto the gold surface, and the signal intensity of current density reaches the mA/cm² scale. Finally, as shown in step 160, a calibration curve can be obtained by integrating the polarization curves of the cyclic voltammetry. The calibration curve is used to determine the concentration of accelerator in a plating bath.

Integration and quantification of the polarization curve

The current of the polarization curve obtained from the cyclic voltammetry indicates the copper deposition, stripping of sulfur-containing accelerators (within cathodic potential), and stripping of copper (within anodic potential). For example, an adsorbed MPS can be electrochemically reduced as follows:
M-S-R+e⁻→M+R-S⁻ (1)
Cu²⁺+2e⁻→Cu⁰ (2)

Reaction (1) and reaction (2) indicate the stripping of thiolate and deposition of copper, respectively, wherein both reactions consume electrons. Therefore, the two reactions must be simultaneously considered when the polarization curve is integrated. The conventional analytical method only integrates the polarization curve of the oxidation reaction. In contrast, the analytical method of the present invention integrates the polarization curve of the reduction and oxidation reactions simultaneously to ascertain which polarization curve is proper to do the quantitative analysis, then chooses the proper one to perform the experiment of quantitative analysis. The result of the integration is used to verify the relationship between sulfur-containing accelerator concentrations and coulombic charge.

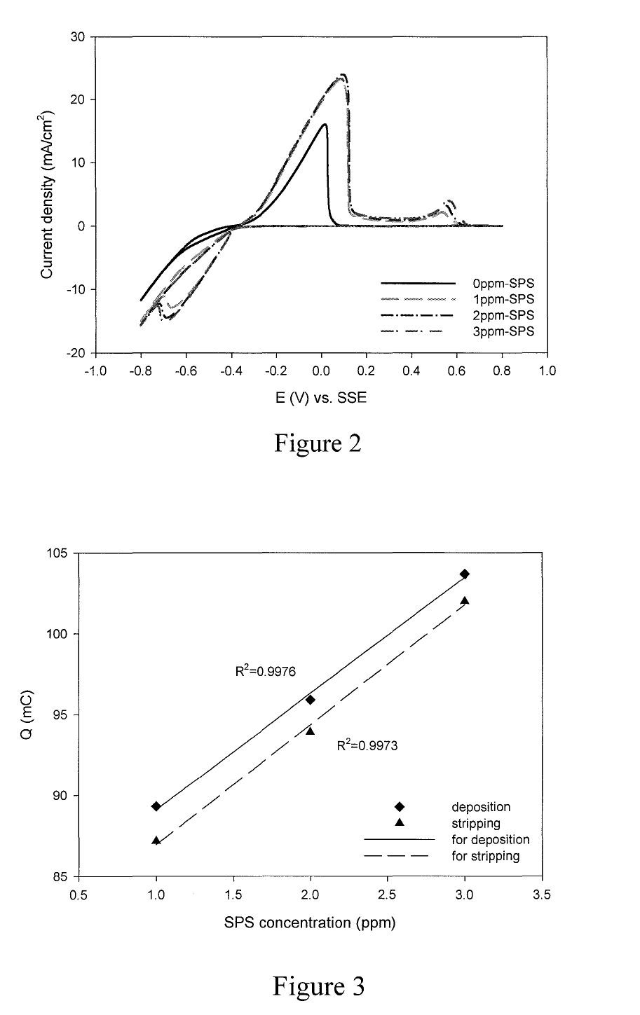

FIG. 2 shows the results of cyclic voltammetry for various SPS concentrations. The polarization curve of the reduction and oxidation reactions are integrated respectively, and the result is shown in FIG. 3, illustrating that the coulombic charge of the reduction reaction (deposition) and oxidation reaction (stripping) both linearly increase with increasing SPS concentration (R-squared value=0.9976). As compared with the coulombic charge of oxidation reaction (stripping) in the cyclic voltammetry, the integrated coulombic charge of reduction reaction (deposition) is dominant. That is, the produced current within cathodic potential not only indicated the copper deposition on the gold electrode but also a synergy of additives in the plating solution, such as the stripping of the sulfur-containing accelerator. Consequently, when the SPS concentration analysis is carried out, the integrated coulombic charge of the reduction reaction is applied to plot an accurate calibration curve for quantifying the accelerator concentration.

The composition of deposition electrolyte for copper deposition

Various composition of deposition electrolytes were formulated to find out the preferred composition of deposition electrolyte for copper deposition, so as to enhance the electric signal measured from samples and plot an accurate calibration curve.

Demonstration 1

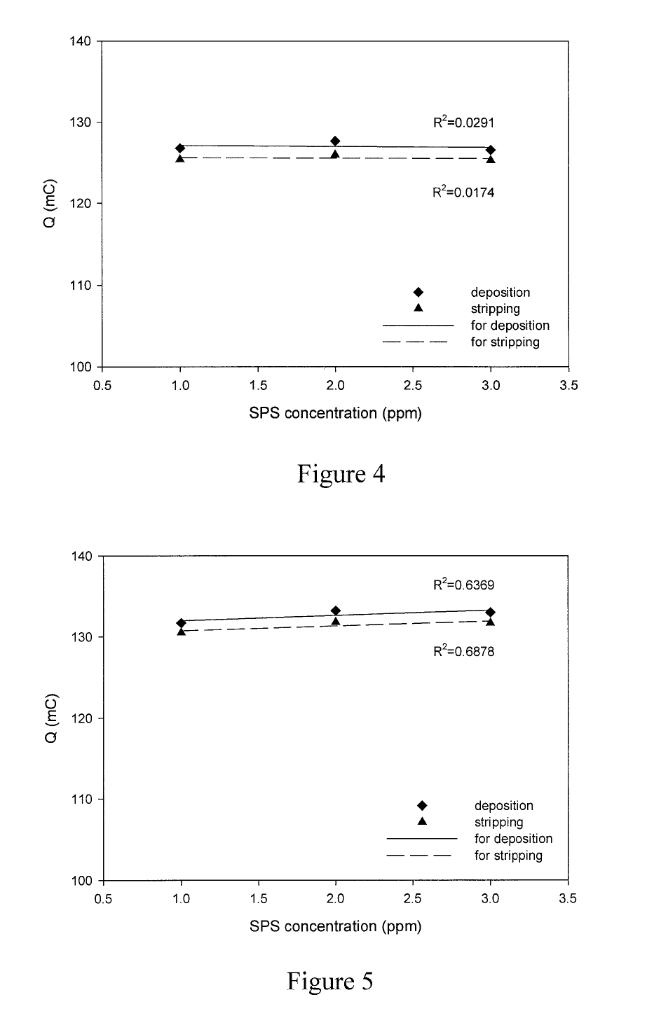

FIG. 4 shows a calibration curve obtained from the cathodic cyclic voltammetry with various SPS concentrations in a working electrolyte. The working electrolyte comprised sulfuric acid and cupric sulfate. The SPS concentration is adjusted in the working electrolyte to observe the changes of integrated coulombic charge with various SPS concentrations. As FIG. 4 illustrates, the integrated coulombic charge has no obvious change with the SPS concentration. The calibration curve is not linear (R-squared value=0.0291), so the working electrolyte is improper for accelerator concentration analysis.

Demonstration 2

FIG. 5 calibration curve obtained from the cathodic cyclic voltammetry with various SPS concentrations in a working electrolyte. The working electrolyte comprised sulfuric acid, cupric sulfate and chloride ion. The SPS concentration is adjusted in the working electrolyte to observe the changes of integrated coulombic charge with various SPS concentrations. As illustrated by FIG. 5, the integrated coulombic charge has no obvious change with the SPS concentration. The calibration curve is not linear (R-squared value=0.6369), so the working electrolyte is improper for accelerator concentration analysis.

Demonstration 3

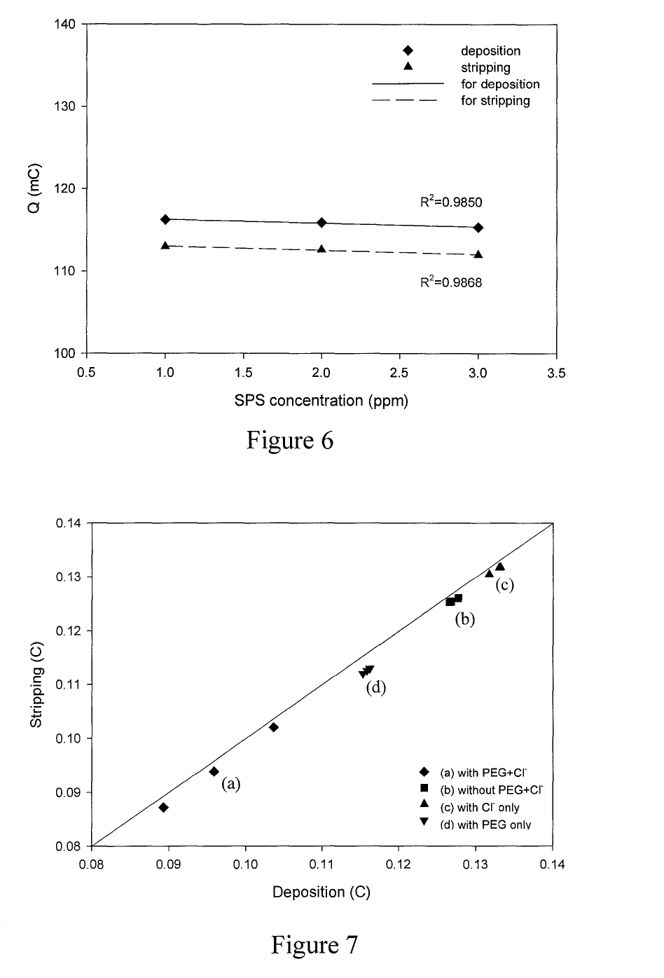

FIG. 6 shows a calibration curve obtained from the cathodic cyclic voltammetry with various SPS concentrations in a working electrolyte. The working electrolyte comprised sulfuric acid, cupric sulfate, and PEG. The SPS concentration is adjusted in the working electrolyte to observe the changes of integrated coulombic charge with various SPS concentrations. As illustrated by FIG. 6, the integrated coulomb charge slightly reduced with increasing SPS concentration (R-squared value=0.985). Although the change of integrated coulombic charge with various SPS concentrations is linear, but the change is tiny. Because such tiny change in coulombic charge caused by accelerator concentration change can be easily confused with the tiny change in coulombic charge caused by experimental error, which produces error in determining accelerator concentration, the working electrolyte is improper for accelerator concentration analysis.

Demonstration 4

FIG. 7 shows comparative calibrations with SPS concentrations, which were obtained from the preferred embodiment of present invention and other electrolytes. The feature of the preferred embodiment of the present invention is that it contains two additives, PEG and chloride ion.

As illustrated in FIG. 7, (a) is the integrated coulombic charge measured from an electrolyte that contains PEG and chloride ion (obviously, the coulombic charge increased with increasing SPS concentration); (b) is the integrated coulombic charge measured from an electrolyte without PEG and chloride ion (the coulombic charge shows no distinct increase with increasing SPS concentration); (c) is the integrated coulombic charge measured from an electrolyte with Chloride ion only; and (d) is the integrated coulombic charge measured from an electrolyte with PEG only (both have no distinct increase with increasing SPS concentration). Therefore, coulombic charge only increased with increasing SPS concentration in presence of both PEG and chloride ion. The electrolyte, which contains both PEG and chloride ion, has significant changes of coulombic charge and shows a linear calibration curve as compared with other electrolytes (i.e. electrolyte (b), (c), and (d)). For this reason, the copper deposition step has to be carried out in an electrolyte with PEG and chloride ion simultaneously to bring about an obvious current peak in the cyclic voltammetry.

Demonstration 5

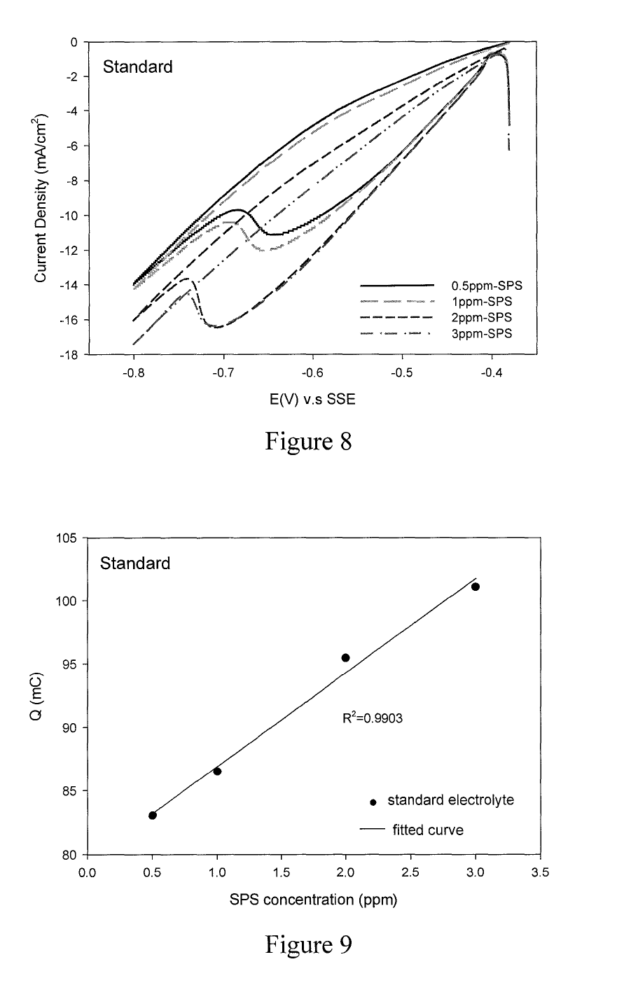

FIG. 8 shows a polarization curve obtained from the cathodic cyclic voltammetry with various SPS concentrations in the electrolyte of the preferred embodiment of the present invention. The electrolyte comprised sulfuric acid, cupric sulfate, PEG, and chloride ion. With increasing of the SPS concentration, the signal peak become larger. That indicates the increase of the adsorption amount of SPS on the gold electrode. As illustrated in FIG. 9, the coulombic charge increased with the SPS concentration to yield a linear calibration curve, so that the electrolyte of the preferred embodiment of the present invention is proper to analyze the accelerator concentration.

The embodiment of the present invention provides a deposition electrolyte, which contains PEG and chloride ion for copper deposition onto the gold surface. Then, a current peak was obtained in the cyclic voltammetry and the signal intensity of the current density reaches the mA/cm² scale. Because the efficiency of copper deposition onto the gold electrode and the diameter of deposited copper particles are proportional to the concentration of sulfur-containing accelerators in the plating solution, the signal intensity of current density can reach the mA/cm² scale.

Furthermore, the integrated coulombic charge can exhibit the variations in various concentration of sulfur-containing accelerators adsorbed onto the gold electrode, so the method of present invention can be applied to analyze accelerator concentration more accurately.

Moreover, according to the above-mentioned approaches, there are many advantages of the present invention over the prior art. This invention provides a feasible and convenient analysis method to quantify the accelerator concentration in a plating solution, and is also based on and extends existing analytical techniques. That is, the present invention combines the selective adsorption step and the electrochemical deposition step to amplify the measured electrochemical signals to obtain a more accurate calibration curve.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of analyzing accelerator in copper electroplating, comprising:
putting a gold electrode in a plating solution, which contains organic additives;
dipping the gold electrode into the plating solution to perform a pre-adsorption step;
putting the gold electrode into an electrolyte;
performing a cathodic cyclic voltammetry (CCV) to deposit copper in the electrolyte; and
integrating coulombic charge to make a calibration curve.

2. The method of claim 1, wherein the temperature of the plating solution is kept at 20˜30° C.

3. The method of claim 1, wherein the plating solution comprises:
a copper ion, selected from the group consisting of cupric sulfate anhydrous, cupric sulfate (CuSO₄), cupric carbonate (CuCO₃), cupric nitrate (Cu(NO₃)₂), cupric oxide (CuO) and a mixture thereof;
an acid, which comprises sulfuric acid (H₂SO₄);
a leveler;
a polyethylene compound, selected from the group consisting of polyethylene glycol (PEG), polypropylene glycol (PPG), polyethylene oxide (PEO), polyethylene glycol tert-octylphenyl ether (Triton X-405) and a mixture thereof;
a halogen, selected from the group consisting of chloride ion, and bromide ion ; and
an accelerator, selected from the group consisting of Bis-(3-Sulfopropyl) Disulfide (SPS), 3-Mercapto-1-Propane Sulfonate (MPS), N,N-dimethyl-dithiocarbamyl propyl sulfonic acid (DPS), 3-S-lsothiuronium propyl Sulfonate (UPS), 3-(Benzothiazolyl-2-mercapto)-propyl-sulfonic acid (ZPS) and a mixture thereof.

4. The method of claim 1, wherein the duration of the pre-adsorption step is 15 to 45 minutes.

5. The method of claim 1, wherein the electrolyte comprises:
a copper ion, selected from the group consisting of cupric sulfate anhydrous, cupric sulfate (CuSO₄), cupric carbonate (CuCO₃), cupric nitrate (Cu(NO₃)₂), cupric oxide (CuO) and a mixture thereof;
an acid, which comprises sulfuric acid (H₂SO₄);
a polyethylene compound, selected from the group consisting of polyethylene glycol (PEG), polypropylene glycol (PPG), polyethylene oxide (PEO), polyethylene glycol tertoctylphenyl ether (Triton X-405) and a mixture thereof; and
a halogen, which comprises chloride ion and bromide ion.

6. The method of claim 1, wherein the CCV is performed at a scan rate of 1˜20 mV/s.

7. An electrolyte for depositing metallic copper particles, which comprises:
a copper ion;
an acid;
a polyethylene compound; and
a halogen.

8. The electrolyte of claim 7, wherein the copper ion is selected from the group consisting of cupric sulfate anhydrous, cupric sulfate (CuSO₄), cupric carbonate (CuCO₃), cupric nitrate (Cu(NO₃)₂), cupric oxide (CuO), and a mixture thereof.

9. The electrolyte of claim 8, wherein the copper ion is cupric sulfate (CuSO₄) in the form of copper sulfate pentahydrate (CuSO₄.5H₂O), and the concentration of the copper sulfate pentahydrate is 150˜250 g/L.

10. The electrolyte of claim 7, wherein the acid is sulfuric acid (H₂SO₄), and the concentration of the sulfuric acid is 30˜100 g/L.

11. The electrolyte of claim 7, wherein the polyethylene compound is selected from the group consisting of polyethylene glycol (PEG), polypropylene glycol (PPG), polyethylene oxide (PEO), polyethylene glycol tert-octylphenyl ether (Triton X-405), and a mixture thereof.

12. The electrolyte of claim 7, wherein the molecular weight of the polyethylene compound is 1000 to 20000.

13. The electrolyte of claim 11, wherein the concentration of the polyethylene compound is 50 to 400 ppm.

14. The electrolyte of claim 7, wherein the halogen is selected from the group consisting of chloride ion and bromide ion.

15. The electrolyte of claim 14, wherein the concentration of the halogen is about 30 to 100 ppm.
